(19) United States
(12) Patent Application Publication
(10) Pub. No.: US 2001/0037260 A1
(43) Pub. Date: Nov. 1, 2001

(54) Method for processing payments and deliveries in electronic commerce business and record medium therefor

(75) Inventor: Ki Yeol Kim, Seoul (KR)

Correspondence Address: Ladas & Parry, 26 West 61st Street, New York, NY, 10023, US

(73) Assignee: E-NET CO., LTD.

(21) Appl. No.: 09/837,948

(22) Filed: Apr. 19, 2001

(30) Foreign Application Priority Data
Apr. 28, 2000 (KR) P2000-22977
Apr. 29, 2000 (KR) P2000-23144

(51) Int. Cl. G06F 17/60

(52) U.S. Cl. 705/26

(57) ABSTRACT

The present invention relates to a computer-readable record medium for storing programs of realizing a method for processing payments and deliveries in the electronic commerce business.

The present invention provides a computer-readable record medium for storing programs of realizing the method for processing payments and deliveries in the electronic commerce business by selectively inputting installments and plural payment methods upon inputting a customer's payment information and various delivery information in the electronic commerce business.

The present invention, in a method for processing payments and deliveries in the electronic commerce business, comprises steps of (S1) confirming member information inputted by a user at an internet shopping mall; (S2) displaying a list of items on a web browser of the user if the inputted member information is a member's ID and password as a result of the confirmation of step S1; (S3) inputting signals of user's item selections and purchases and pre-paid amount payment at the internet shopping mall; (S4) confirming the pre-paid amount payment, notifying the user of deliveries, and completing the deliveries at the internet shopping mall; (S5) receiving from the user the remaining amount payment for items whose deliveries are completed.

### BACKGROUND OF THE INVENTION

1. Field of the Invention

The present invention relates to a method for processing payments and deliveries in electronic commerce business and a computer-readable record medium for storing programs of realizing the method, and more particularly to a method for processing payments and deliveries in electronic commerce business and a computer-readable record medium for storing programs of realizing the method, which can make payments in installments or diverse payment ways with respect to one order in the electronic commerce business as well as designate various delivery destinations for ordered goods.

2. Description of the Related Art

FIGS. 1 is an illustrative flow for showing a conventional payment and delivery process in the electronic commerce business.

A conventional order processing procedure in a shopping mall of the conventional electronic commerce business is as follows.

First, an order is received from a consumer(11), and a payment process is carried out accordingly(12). The shopping mall that has received the order from the consumer and confirmed the payment notifies of a delivery (13), and confirms that the delivery has been actually completed(14). That is, as shown in FIG. 1, the process is carried out through the steps of order → payment → delivery notification → delivery completion. At this time, the shopping mall confirms the payment, and, if the payment is confirmed, the shopping mall notifies a user of the delivery and completes the delivery, and, if the payment is not confirmed, the shopping mall takes the purchase as cancelled, and does not carry out the steps of the delivery notification and the delivery.

However, the conventional payment processing method in the commerce business as stated above has a problem of affecting a negative effect on the customer's satisfaction degree and causing sales decreases of internet shopping malls due to a large time difference between the time goods is purchased and the time the actually purchased goods is delivered since the delivery notification to a user is carried out after a payment confirmation.

FIG. 2 is an illustrative view for showing a relationship between payments and delivery information based on an order number in the electronic commerce business with a shopping mall of the conventional electronic commerce business If a consumer makes an order as shown in FIG. 1, one order number 22 is generated at the electronic commerce business shopping mall, one order number 22 is connected to one payment information 21, one order number 22 is plural goods 23, and the plural goods 23 are connected to one delivery information, to thereby process data.

Accordingly, the shopping malls of the conventional electronic commerce business have a problem in that payments can not be processed when a customer is short of cash or wish to pay with cash and card or with cash and points, beyond the limit of a customer's card such as a credit card for payment. As a result, the payments can be made when he or she has a perfect payment way. That is, a problem occurs in that there is no other way except that order numbers and payment information are connected on a one-to-one basis since one goods is connected to on payment information.

Even in view of the delivery, for example, when buying three items for presents, it is impossible to deliver the items to different persons with one order in the conventional method. If hoping to send items to several people, as many new orders should be made for desired deliveries. Therefore, a problem occurs in that it is inconvenient for customers to use. As a result, a problem occurs in that it can not but have one unique information about a delivery place in case of a single order for plural items.

### SUMMARY OF THE INVENTION

The present invention has been devised to solve the problems as stated above, so it is an object of the present invention to provide a method for processing payments and deliveries in the electronic commerce business and a computer-readable record medium for storing programs of realizing the method, which can settle goods purchase costs in installments of pre-payment and the remaining amount and reduce an actual delivery time by carrying out a delivery notification at an internet shopping mall after the confirmation of the pre-payment.

Further, it is another object of the present invention to provide a method for processing payments and deliveries method in the electronic commerce business and a computer-readable record medium for storing programs of realizing the method, which performs the electronic commerce business by selectively inputting plural payment ways and plural delivery information when a consumer inputs payment information in the electronic commerce business.

That is, it is a further object of the present invention to provide a method for processing payments and deliveries in the electronic commerce business and a computer-readable record medium for storing programs of realizing the method, which constitutes data to carry plural payment ways and plural delivery information for a single order number, enables payments to be carried out by using the plural payment ways as to a payment amount upon inputting payment information of a consumer, and enables plural payments and deliveries to be carried out by inputting plural delivery destination information.

In order to achieve the above objects, the present invention, in a method for processing payments and deliveries in the electronic commerce business comprises steps of (S1) confirming member information inputted by a user at an internet shopping mall; (S2) displaying a list of items on a web browser of the user if the inputted member information is a member's ID and password as a result of the confirmation of step S1; (S3) inputting signals of user's item selections and purchases and pre-paid amount payment at the internet shopping mall; (S4) confirming the pre-paid amount payment, notifying the user of deliveries, and completing the deliveries at the internet shopping mall; (S5) receiving from the user the remaining amount payment for items whose deliveries are completed.

Further, the present invention, in an electronic commerce business payment processing system having a microprocessor and an electronic commerce business payment processing record medium readable by computers and storing a program, realizes a first function for confirming member information inputted by a user at an internet shopping mall; a second function for displaying a list of items on a web browser of the user if the inputted member information is a member's ID and password as a result of the confirmation of the first function; a third function for inputting signals of user's item selections and purchases and pre-paid amount payment at the internet shopping mall; a fourth function for confirming the pre-paid amount payment, notifying the user of deliveries, and completing the deliveries at the internet shopping mall; and a fifth function for receiving from the user the remaining amount payment for items whose deliveries are completed.

Further, the present invention, in a method for processing payments and deliveries in the electronic commerce business, which is applied to a communication system, comprises steps of (S1) receiving item orders from a user at an electronic commerce business shopping mall; (S2) notifying the user that an amount of the ordered items may be paid in a combination of various payment methods and plural delivery destinations may be processed as to one order; (S3) storing diverse payment information in association with the user's item order according to user's selections as to the payment methods and confirming payments according to payment methods; and (S4) storing diverse delivery information in association with an order according to the user's selections as to delivery methods and processing deliveries according to the delivery methods.

Further, the present invention, in an electronic commerce business payment processing system having a microprocessor of large capacity and a computer-readable record medium for storing a program, realizes a first function for receiving item orders from a user at an electronic commerce business shopping mall; a second function for notifying the user that an amount of the ordered items may be paid in a combination of various payment methods and plural delivery destinations may be processed as to one order; a third function for storing diverse payment information in association with the user's item order according to user's selections as to the payment methods and confirming payments according to payment methods; and a fourth function for storing diverse delivery information in association with an order according to the user's selections as to delivery methods and processing deliveries according to the delivery methods.

Further, the present invention, in a method for processing payments and deliveries in the electronic commerce business, which is applied to a communication system, comprises steps of (S1) receiving item orders from a user at an electronic commerce business shopping mall; (S2) notifying the user of the possibility of installments, and that the an amount of the ordered items may be paid in a combination of various payment methods and plural delivery destinations may be processed as to one order if the user selects the installments; (S3) storing diverse payment information in association with the user's item order according to user's selections as to the payment methods and confirming payments according to payment methods; (S4) storing diverse delivery information in association with an order according to the user's selections as to delivery methods and processing deliveries according to the delivery methods; (S5) notifying the user that the amount of the ordered items may be paid in a combination of the various payment methods if the user wants to pay the remaining amount after the completion of the delivery; and (S6) storing the diverse payment methods according to the user's selections as to the payment method and confirming the payment according to the payment method.

Further, the present invention, in a computer-readable record medium, realizes a first function for receiving item orders from a user at an electronic commerce business shopping mall; a second function for notifying the user of the possibility of installments, and that the an amount of the ordered items may be paid in a combination of various payment methods and plural delivery destinations may be processed as to one order if the user selects the installments; a third function for storing diverse payment information in association with the user's item order according to user's selections as to the payment methods and confirming payments according to payment methods; a fourth function for storing diverse delivery information in association with an order according to the user's selections as to delivery methods and processing deliveries according to the delivery methods; a fifth function for notifying the user that the amount of the ordered items may be paid in a combination of the various payment methods if the user wants to pay the remaining amount after the completion of the delivery; and a sixth function for storing the diverse payment methods according to the user's selections as to the payment method and confirming the payment according to the payment method.

### BRIEF DESCRIPTION OF THE DRAWINGS

The above objects and other advantages of the present invention will become more apparent by describing in detail a preferred embodiment thereof with reference to the attached drawings, in which:

FIG. 1 is an illustrative flow chart for processing payments and deliveries in a conventional electronic commerce business;

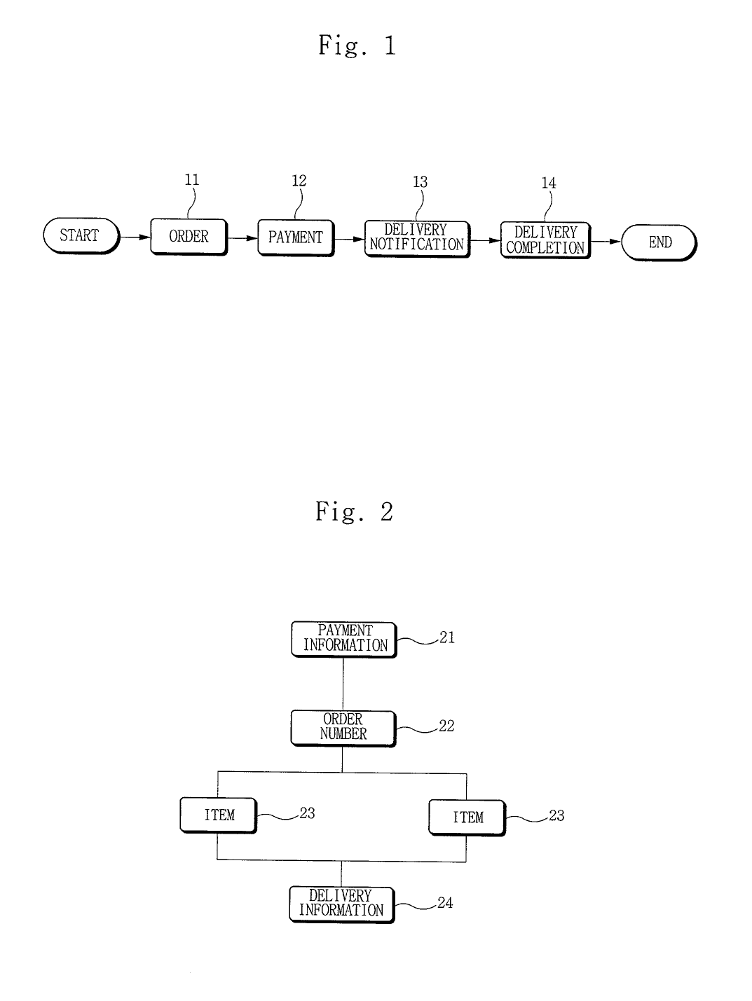

FIG. 2 is an illustrative view for showing a relationship of payments and delivery information to an order number when in electronic commerce business at a shopping mall of a conventional electronic commerce business;

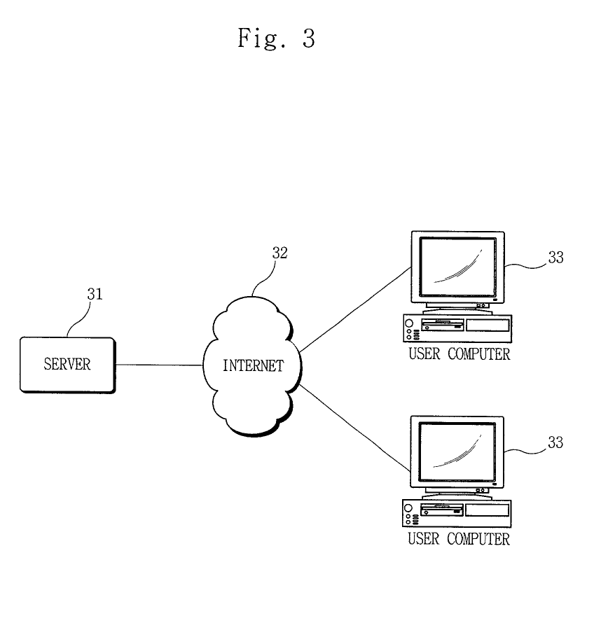

FIG. 3 is an illustrative view for showing a structure of a network system according to which the present invention is applied;

FIG. 4 is a flow chart of a method for processing payments and deliveries in the electronic commerce business according to a preferred embodiment of the present invention;

FIG. 5 is a view for explaining a relationship of payments and delivery information to an order number in a method for processing payments and deliveries according to a second embodiment of the present invention;

FIG. 6 is a view for explaining data fields for storing data processed in a method for processing payments and deliveries according to the second embodiment of the present invention;

FIG. 7a and FIG. 7b are flow charts of a method for processing payments and deliveries in the electronic commerce business according to the second embodiment of the present invention;

FIG. 8 is a view for explaining a relationship of payments and delivery information to an order number in a method for processing payments and deliveries according to a third embodiment of the present invention; and

FIG. 9a and FIG. 9b are flow charts of a method for processing payments and deliveries in the electronic commerce business according to the third embodiment of the present invention.

### DETAILED DESCRIPTION OF THE PREFERRED EMBODIMENTS

The above objects, characteristics, and advantages of the present invention will become more apparent by describing in detail preferred embodiments thereof with reference to the attached drawings. Hereinafter, a preferred embodiment of the present invention will be described in detail with reference to the accompanying drawings.

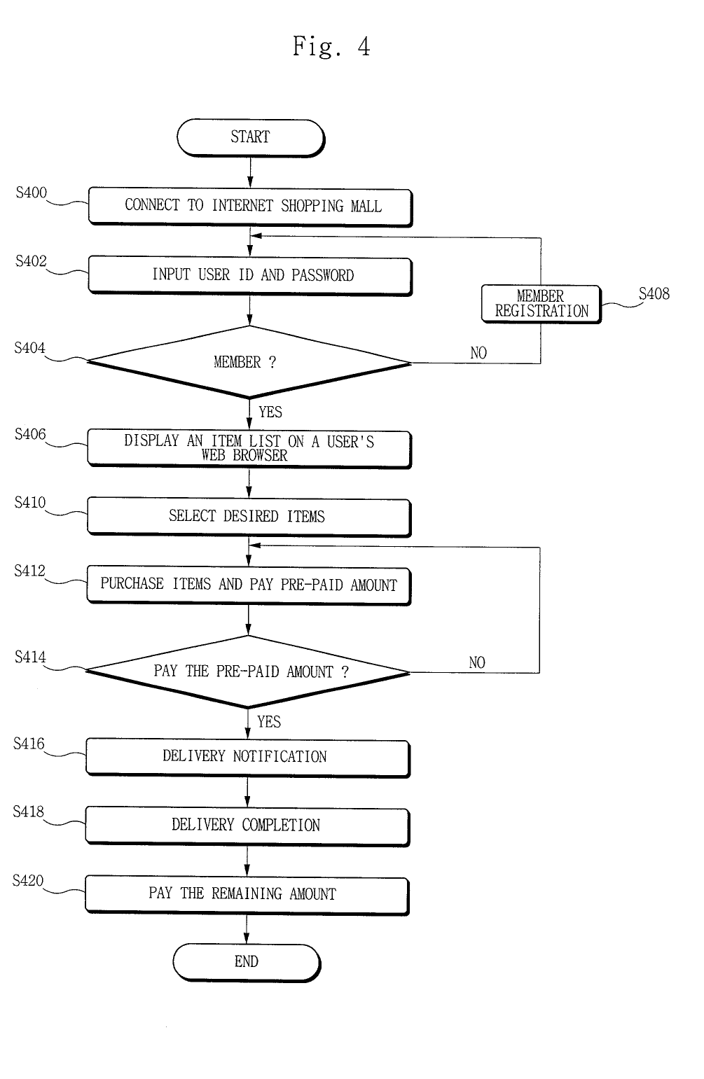

FIG. 3 is an illustrative view for showing a structure of a network system to which the present invention is applied.

The network system for the electronic commerce business to which the present invention is applied includes a server 31, the internet 32, and user computers 33.

At this time, the server 31 opens and provides to consumers a shopping mall for the electronic commerce business through the internet 32.

The user computers 33 can connect to the server 31 through the internet 32 and then visit the shopping mall opened for the electronic commerce business in the server 31.

The internet 32 plays a role of connecting through the network the server 31 for providing services and information and the user computers 33 of consumers who hope to use them.

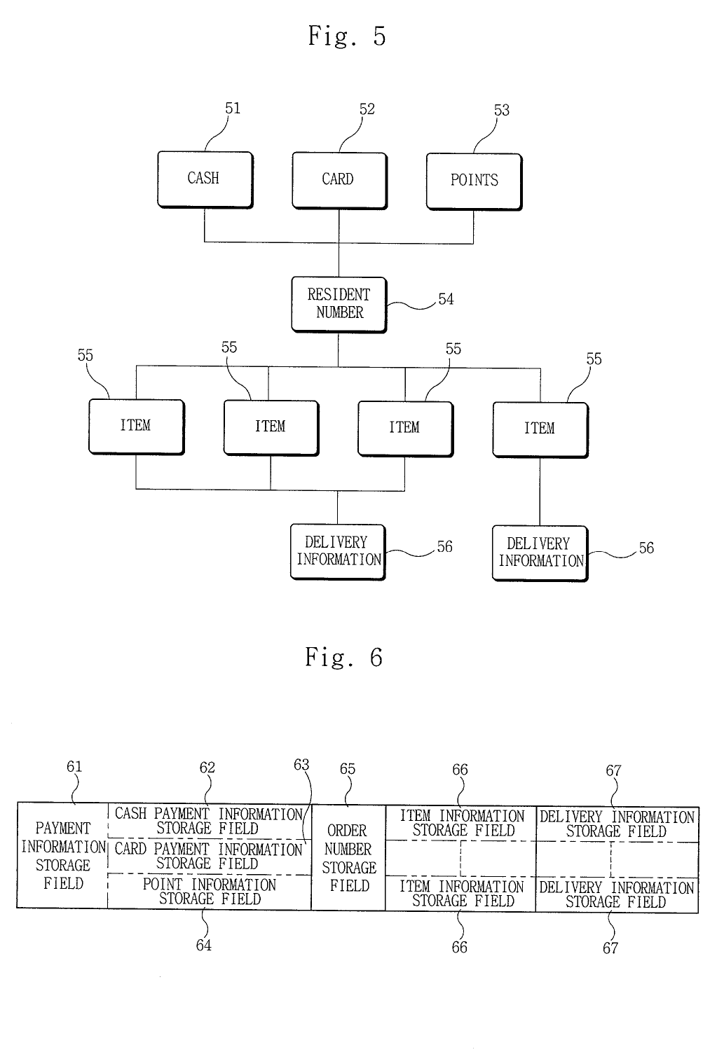

FIG. 4 is a flow chart of a method for processing payments and deliveries in the electronic commerce business according to a preferred embodiment of the present invention.

First, if a user connects to an internet shopping mall through the internet(S400) and inputs member information, that is, a user ID and a password to a home page of the internet shopping mall(S402), the internet shopping mall judges if the user ID and password are the user ID and password for a member(S404).

As a result of the judgment(S404), if the user ID and password are for a member, the internet shopping mall displays a goods list on a user's web browser(S406), and, if the user ID and password are not for a member, the internet shopping mall carries out a certain member registration procedure(S408), and repeats the step S402 for inputting the user ID and password.

A user selects goods he or she wants from the goods list outputted on the web browser(S410), purchases the goods, and carries out a payment with a pre-paid amount(S412). At this time, a pre-paid amount payment method may be a method of using a pre-paid deposit or a method of paying with mileages or points given according to a purchase history of a user, which rapidly processes a pre-paid payment confirmation.

Further, the internet shopping mall confirms the pre-paid payment(S414), and, if the payment is confirmed, the internet shopping mall notifies a user of delivery(S416), completes the delivery(S418), and, if the payment is not confirmed, the internet shopping mall repeats the step S412 for carrying out the goods purchase and pre-paid amount payment. Here, a method for confirming the pre-paid amount payment may be a method a shopping mall administrator manually confirms the payment or a method a shopping mall program automatically confirms the payment, but the present invention is supposed to use the method the shopping mall program automatically confirms the payment for shortening a delivery period of time.

Last, if the delivery of the goods a user have purchased is completed, the user pays the remaining amount except the pre-paid amount from the goods purchase amount(S420).

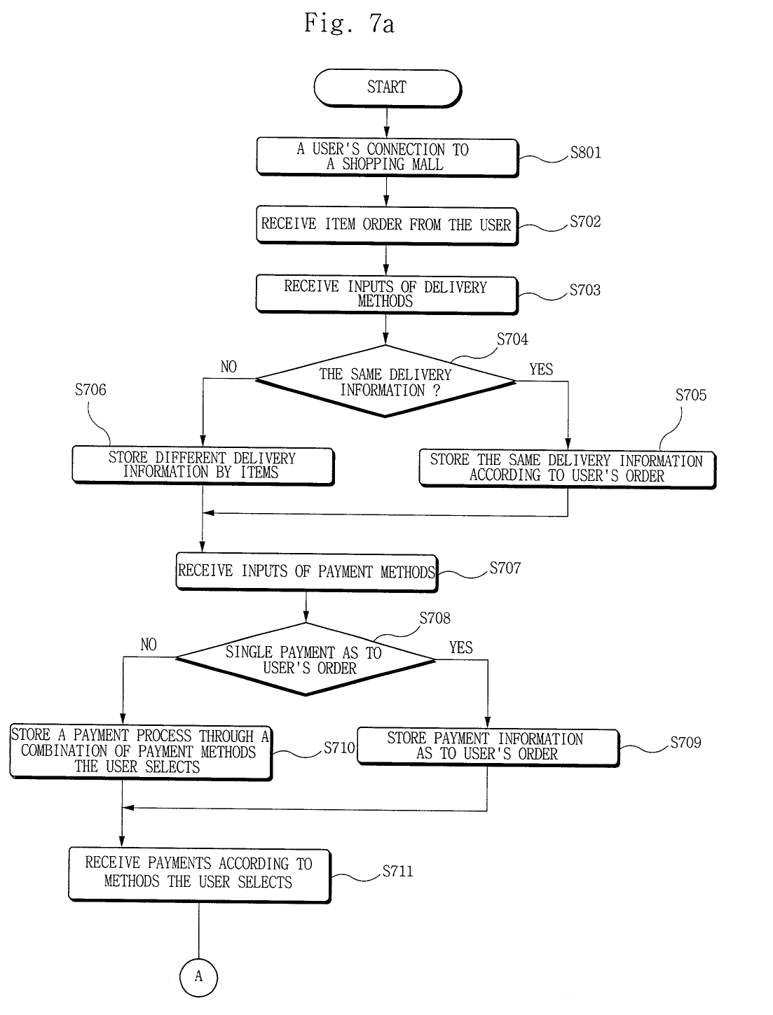

FIG. 5 is a view for explaining a relationship of payments and delivery information to an order number in a method for processing payments and deliveries according to a second embodiment of the present invention.

When there are plural items as to one order upon order at an online shopping mall, plural payment ways such as cash 51, cards 52, points 53, and the like as to one order as shown in FIG. 5 can be inputted at the same time. At this time, the payments are not made by using different payment ways as to payment amounts for respective items, but a total payment amount can be paid by using the various payment ways each of which pays part of the total payment amount.

As in the prior art, plural items 55 are connected as to one order number, and various delivery information 56 and 57 can be inputted for the items 55. Plural delivery information can be inputted without orders by items for different delivery destinations as in the conventional method. At this time, a user can either input the delivery information as to each item of the user's selecting or input delivery information as to selectively packaged items.

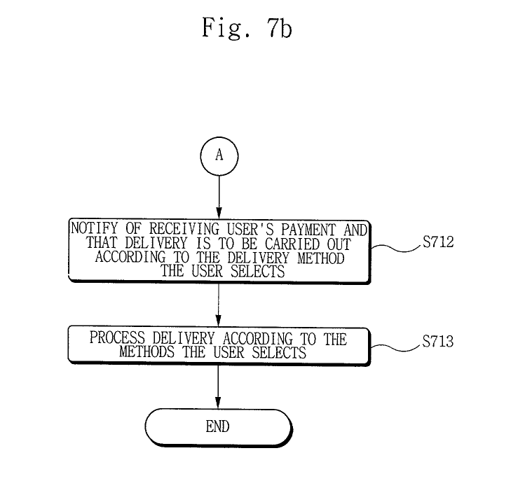

FIG. 6 is a view for explaining data fields for storing data processed in a method for processing payments and deliveries according to the second embodiment of the present invention.

The server 31 which provides a shopping mall for the electronic commerce business stores data in a database in order to process user's orders. At this time, the data field form is as follows.

First, there exists an order number storage field 65 which is a key word for enabling a user's order to be identified. Payment ways of a user as to the order stored in the order number storage field 65 is stored in a payment information storage field 61, and the payment information storage field 61 is connected to a cash payment information storage field 62, a card payment information storage field 63, and a point payment information storage field 64. in accordance with payment methods a user is inputted, the sum of payment amounts to be paid is equal to the sum of ordered amounts by the user. The payment information storage field 61 stores information indicating by what method payments are carried out, so that confirmations can be made on what payment methods of case, cards, and points are used and how they are used, singly or in combination, according to the data stored in the payment information storage field 61.

In anther way, a total payment amount according to user's orders is stored in the payment information storage field 61, which is matched with a sum of the payment amounts stored in a cash payment information storage field 62, a card payment information storage field 63, and a point payment information storage field 64, so that the payment information can be stored.

Plural goods information storage fields 66 can be matched to each order number stored in the order number storage field 65, which are values stored as to the plural goods information selected with one order of a user.

The goods information storage fields 66 in which goods information is stored matches with the delivery information storage fields 67 in a one-to-one basis, which is determined according to a user's input value for the delivery information on goods selected by the user upon order. A user can either input the same delivery information as to respective items or input different delivery information as to only particular items. Such inputs of the user can match with goods information for storage.

That is, it is the same as the prior art that a user requests diverse items as to one order, which can be processed by using various payment methods as well as with various delivery information.

Such information is recorded in a database.

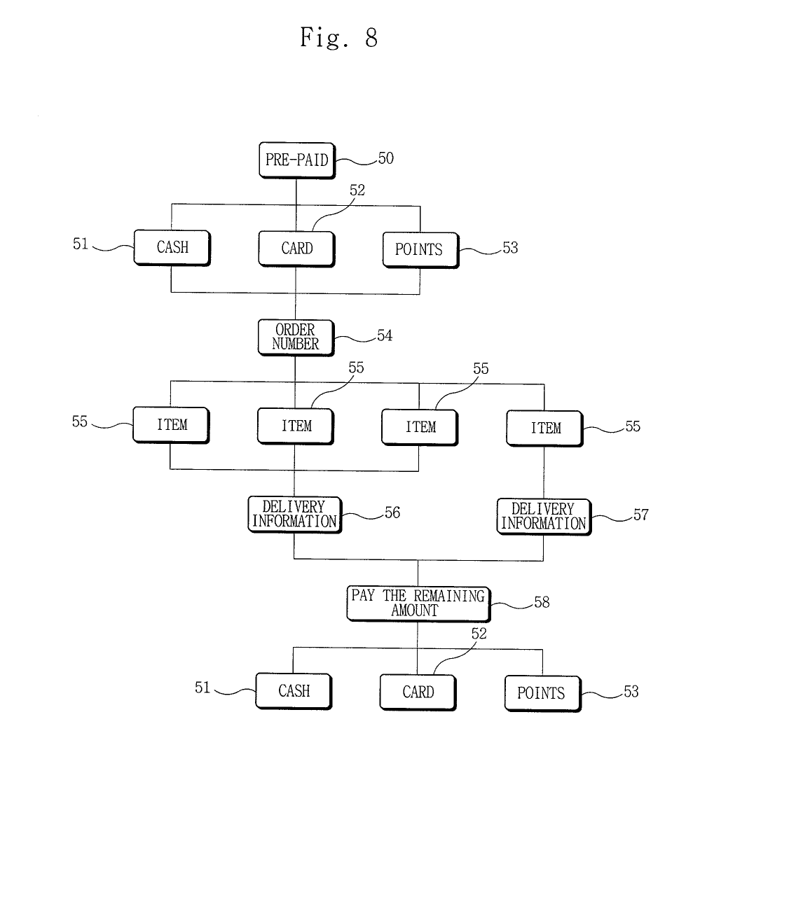

FIG. 7a and FIG. 7b are flow charts of a method for processing payments and deliveries in the electronic commerce business according to the second embodiment of the present invention. A shopping mall of an electronic commerce business receives a user's connection(S701), receives orders of items from the user who has confirmed goods information(S702), and receives goods delivery methods from the user(S703). At this time, the delivery of the items the user has selected can be designated either to the same address for all items or to different addresses by items, the designations are notified to the user, and then the user determines and inputs the delivery methods in ways suitable for himself or herself.

The shopping mall inputs the user's delivery information, and confirms if inputted as single delivery information(S704). That is, the shopping mall confirms if the user orders a single item or if the user determines and inputs the delivery destination as the same place for all items he or she has ordered.

As a result of the confirmation, if the user inputs single delivery information, it is stored that the user's order has the same delivery information(S705). That is, it is stored as delivery information according to an order number.

As a result of the confirmation, if the user inputs diverse delivery information instead of single delivery information, the delivery information is stored by items the user has ordered(S706).

The shopping mall requests the user to input information for payment methods(S707). At this time, the shopping mall notifies the user that payments can be made with a signal method as well as with diverse methods.

That is, the shopping mall notifies the user that the entire payments can be made by adding a cash payment and card payments, or by a cash payment for the remaining amount after a points payment, or the like, and receives user's payment method accordingly.

The shopping mall judges if a payment for the user's order is a single payment(S708), and, as a result of the judgment, if single, single payment information is stored for the entire orders of the user(S709). That is, according to the payment method the user has selected, the fact that the single payment is made and payment information as to how the payment is performed are stored.

As a result of judging if the payment as to the user's order is a single payment, if not single, the shopping mall stores that the payment is made through a combination of the payment methods the user has selected(S710). That is, the fact that the payment is made by combining various payment methods as to the entire payment amount and the payment information as to how the payment is made are stored.

The shopping mall receives the payment according to the method the user has selected(S711). Further, the shopping mall notifies the user of the receipt of the payment and that the goods delivery are to be carried out according to the delivery method the user has selected(S712). The shopping mall carries out the delivery process according to the method the user has selected(S713).

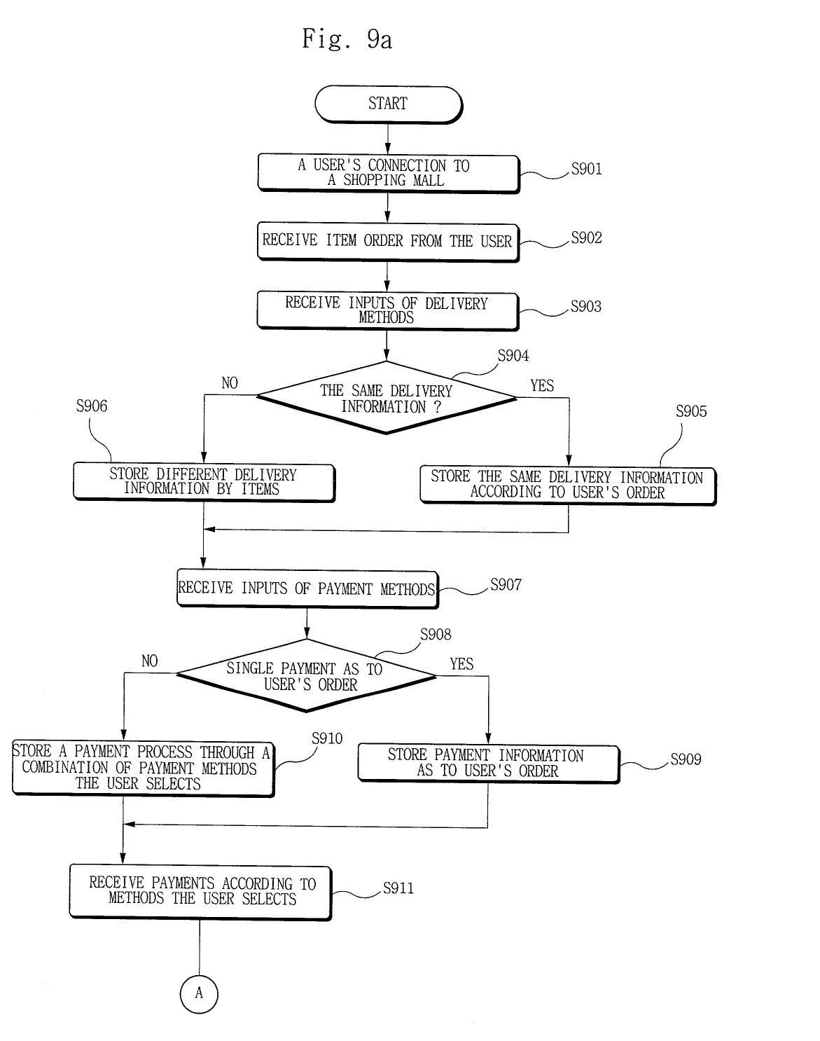

FIG. 8 is a view for explaining a relationship of payments and delivery information to an order number in a method for processing payments and deliveries according to a third embodiment of the present invention.

As shown in FIG. 8, a user in an online shopping mall selects and purchases goods he or she wants from a goods list outputted on a web browser and selects a pre-paid amount payment 50. Further, together with the pre-paid amount payment method, plural payment methods such as cash 51, cards 52, points 53, and so on can be used at the same time through inputs thereof. At this time, the payment is not made by using one payment method as to the payment amount of each item, but various payment methods can pay parts of the total payment amount.

Like the prior art, plural items 55 are connected to one order number, and various delivery information 56 and 57 can be inputted for the items 55. Therefore, plural delivery destination information can be inputted, without orders by items for different delivery destinations like the prior art. At this time, the delivery information can be inputted as to respective items by user's selections as well as the delivery information can be inputted as to selectively packaged items.

In the meantime, if the delivery of the items a user has purchased is completed, the remaining amount 58 to be paid except the pre-paid amount from the total purchase amount of the items is paid. Further, plural payment methods such as cash 51, cards 52, points 53, and the like can be used at the same time as the payment methods for the remaining amount.

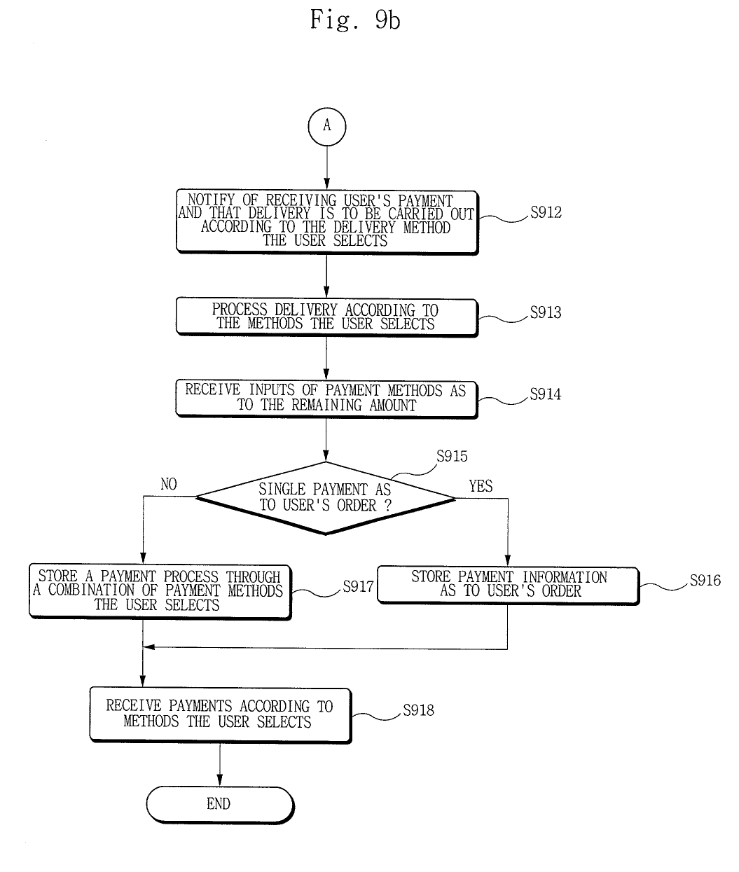

FIG. 9a and FIG. 9b are flow charts of a method for processing payments and deliveries in the electronic commerce business according to the third embodiment of the present invention.

A shopping mall of an electronic commerce business is connected by a user (S901). The shopping mall receives goods orders from the user who has confirmed goods information(S902). The shopping mall inputs delivery methods from the ordered items from the user(S903). At this time, the delivery for all the items the user has selected can be made to the same address or to different addresses by items, which is notified to the user. The user determines and inputs the delivery methods fit for himself or herself.

The shopping mall inputs the delivery information, and confirms if single delivery information is inputted(S904). That is, the shopping mall confirms if the user orders a single item or if the user determines and inputs the delivery destination as the same place for all items he or she has ordered.

As a result of the confirmation, if the user inputs single delivery information, it is stored that the user's order has the same delivery information(S905). That is, it is stored as delivery information according to an order number.

As a result of the confirmation, if the user inputs diverse delivery information instead of single delivery information, the delivery information is stored by items the user has ordered(S906).

Thereafter, the shopping mall notifies the user that the payment can be made in installments, and, if the user selects the installments, the shopping mall notifies the user that the payment of a pre-paid amount can be made with a signal method as well as with diverse methods. That is, the shopping mall notifies the user that the entire payments can be made by adding a cash payment and card payments, or by a cash payment for the remaining amount after a points payment, or the like, and receives user's payment methods accordingly(S907).

The shopping mall judges if a payment for the user's order is a single payment(S908), and, as a result of the judgment, if single, single payment information is stored for the entire orders of the user(S909). That is, according to the payment method the user has selected, the fact that the single payment is made and payment information as to how the payment is performed are stored.

As a result of judging if the payment as to the user's order is a single payment, if not single, the shopping mall stores that the payment is made through a combination of the payment methods the user has selected(S910). That is, the fact that the payment is made by combining various payment methods as to the entire payment amount and the payment information as to how the payment is made are stored.

The shopping mall receives the pre-paid payment according to the method the user has selected(S911). Further, the shopping mall notifies the user of the receipt of the payment and that the goods delivery are to be carried out according to the delivery method the user has selected(S912). The shopping mall carries out the delivery process according to the method the user has selected(S913).

If the user wants to pay the remaining amount, the shopping mall notifies the user that the payment of the remaining amount can be made with a signal method as well as with diverse methods. That is, the shopping mall notifies the user that the entire payments can be made by adding a cash payment and card payments, or by a cash payment for the remaining amount after a points payment, or the like, and receives user's payment methods accordingly(S914).

The shopping mall judges if a payment for the user's order is a single payment(S915), and, as a result of the judgment, if single, single payment information is stored for the entire orders of the user(S916). That is, according to the payment method the user has selected, the fact that the single payment is made and payment information as to how the payment is performed are stored.

As a result of judging if the payment as to the user's order is a single payment, if not single, the shopping mall stores that the payment is made through a combination of the payment methods the user has selected(S917). That is, the fact that the payment is made by combining various payment methods as to the entire payment amount and the payment information as to how the payment is made are stored.

The shopping mall receives the payment of the remaining amount according to the method the user has selected(S918).

Although the preferred embodiments of the present invention have been described, it will be understood by those skilled in the art that the present invention should not be limited to the described preferred embodiments, but various changes and modifications can be made within the spirit and scope of the present invention as defined by the appended claims.

The present invention as stated above reduces the time required in payment confirmations by notifying a user of deliveries after the completion of the pre-paid amount payment confirmations and employing user's pre-paid deposit, mileages, and points as pre-paid amount payment methods, so an effect can be expected which increases a customer's satisfaction degree and increases sales of the internet shopping malls accordingly.

Further, in processing payments and deliveries as to one order in a shopping mall upon an electronic commerce business, the present invention allows plural payments to be made by simultaneously using various payment methods as to an order as well allows ordered items to be delivered to different destinations upon ordering plural items, so an effect can be expected which enables a customer to pay in diverse methods, to input different delivery destinations as to plural items, which is impossible in the existing shopping malls, to thereby enhance the convenience of a user.

What is claimed is:

1. A method for processing payments and deliveries in the electronic commerce business, comprising steps of:
(S1) confirming member information inputted by a user at an internet shopping mall;
(S2) displaying a list of items on a web browser of the user if the inputted member information is a member's ID and password as a result of the confirmation of step S1;
(S3) inputting signals of user's item selections and purchases and pre-paid amount payment at the internet shopping mall;
(S4) confirming the pre-paid amount payment, notifying the user of deliveries, and completing the deliveries at the internet shopping mall;
(S5) receiving from the user the remaining amount payment for items whose deliveries are completed; and
(S6) carrying out a predetermined member registration procedure if the member information is not for the ID and password of a member as a result of the confirmation of step S1, and repeating the step S1.

2. The method as claimed in claim 1, wherein the pre-paid payment is made with pre-paid deposits or benefits given according to a purchase history of the user.

3. The method as claimed in claim 1, wherein the pre-paid payment confirmation is automatically made by a shopping mall program to shorten a delivery period of time.

4. In an electronic commerce business payment processing system having a microprocessor and an electronic commerce business payment processing record medium readable by computers and storing a program, the record medium having the program of realizing:
a first function for confirming member information inputted by a user at an internet shopping mall;
a second function for displaying a list of items on a web browser of the user if the inputted member information is a member's ID and password as a result of the confirmation of the first function;
a third function for inputting signals of user's item selections and purchases and pre-paid amount payment at the internet shopping mall;
a fourth function for confirming the pre-paid amount payment, notifying the user of deliveries, and completing the deliveries at the internet shopping mall; and
a fifth function for receiving from the user the remaining amount payment for items whose deliveries are completed.

5. The record medium as claimed in claim 4, wherein the program carries out a predetermined member registration procedure if the member information is not for the ID and password of a member as a result of the confirmation of the first function, and repeating the first function.

6. A method for processing payments and deliveries in the electronic commerce business, which is applied to a communication system, comprising steps of:
(S1) receiving item orders from a user at an electronic commerce business shopping mall;
(S2) notifying the user that an amount of the ordered items may be paid in a combination of various payment methods and plural delivery destinations may be processed as to one order;
(S3) storing diverse payment information in association with the user s item order according to user's selections as to the payment methods and confirming payments according to payment methods; and
(S4) storing diverse delivery information in association with an order according to the user's selections as to delivery methods and processing deliveries according to the delivery methods.

7. The method as claimed in claim 6, wherein the step S3 includes steps of:
(S5) receiving the user's selections as to the payment methods and confirming the selected payment methods;
(S6) storing in a database a fact that the user's item order is carried out with a single payment if the user selects the single payment as a result of the confirmation of the step S5 and the payment methods;
(S7) storing in the database a fact that the user's item order is carried out with plural payments if the user selects payments through a combination of the payment methods as a result of the confirmation of the step S5 and the payment methods; and
(S8) receiving the payment from the user according to the designated methods.

8. The method as claimed in claim 6, wherein the step S4 includes:
(S5) receiving the user's selections as to delivery methods and confirming the methods;
(S6) storing in a database delivery information in association with the user's order if a delivery destination the user selects is a single delivery destination as a result of the confirmation of step S5;
(S11) storing in the database the delivery information associated by the user's order items if the delivery destination the user selects is not a single delivery destination as a result of the confirmation of step S5; and
(S12) confirming the delivery information from the database and delivering the items by delivery destinations.

9. The method as claimed in claim 6, wherein the information according to the user's item order is stored in the database as user's order information in association with an order number, payment information, item information, and delivery information, according to the user's order.

10. The method as claimed in claim 7, wherein the information according to the user's item order is stored as user's order information in association with an order number, payment information, item information, and delivery information, according to the user's order.

11. The method as claimed in claim 8, wherein the information according to the user's item order is stored in the database as user's order information in association with an order number, payment information, item information, and delivery information, according to the user's order.

12. The method as claimed in claim 9, wherein the database includes:
an order number storage field for storing identification information to identify the user's order;
a payment information storage field for storing the payment method and payment information as to the user's order stored in the order number storage field;
an item information storage field for storing the item information the user orders as to the user's order stored in the order number storage field; and
a delivery information storage field for storing the item information the user orders as to the user's order stored in the order number storage field; and
a delivery information storage field for storing the delivery information of items in association with the item information storage field.

13. The method as claimed in claim 12, wherein the payment information storage field includes:
a cash payment information storage field for storing cash payment information such as a payment amount, a payment period of time, a payment method, and so on, to be paid with cash according to the user's selections;
a card payment information storage field for storing card payment information such as a payment amount, a payment period of time, a payment method, and so on, to be paid with a card according to the user's selections; and
a point payment information storage field for storing point payment information such as a payment amount, a payment period of time, a payment method, and so on, to be paid with points according to the user's selections.

14. The method as claimed in claim 10, wherein the database includes:
an order number storage field for storing identification information to identify the user's order;
a payment information storage field for storing the payment method and payment information as to the user's order stored in the order number storage field;
an item information storage field for storing the item information the user orders as to the user's order stored in the order number storage field; and
a delivery information storage field for storing the item information the user orders as to the user's order stored in the order number storage field; and
a delivery information storage field for storing the delivery information of items in association with the item information storage field.

15. The method as claimed in claim 14, wherein the payment information storage field includes:
a cash payment information storage field for storing cash payment information such as a payment amount, a payment period of time, a payment method, and so on, to be paid with cash according to the user's selections;
a card payment information storage field for storing card payment information such as a payment amount, a payment period of time, a payment method, and so on, to be paid with a card according to the user's selections; and
a point payment information storage field for storing point payment information such as a payment amount, a payment period of time, a payment method, and so on, to be paid with points according to the user's selections.

16. The method as claimed in claim 11, wherein the database includes:
an order number storage field for storing identification information to identify the user's order;
a payment information storage field for storing the payment method and payment information as to the user's order stored in the order number storage field;
an item information storage field for storing the item information the user orders as to the user's order stored in the order number storage field; and
a delivery information storage field for storing the item information the user orders as to the user's order stored in the order number storage field; and
a delivery information storage field for storing the delivery information of items in association with the item information storage field.

17. The method as claimed in claim 16, wherein the payment information storage field includes:
a cash payment information storage field for storing cash payment information such as a payment amount, a payment period of time, a payment method, and so on, to be paid with cash according to the user's selections;
a card payment information storage field for storing card payment information such as a payment amount, a payment period of time, a payment method, and so on, to be paid with a card according to the user's selections; and
a point payment information storage field for storing point payment information such as a payment amount, a payment period of time, a payment method, and so on, to be paid with points according to the user's selections.

18. In an electronic commerce business payment processing system having a microprocessor of large capacity and a computer-readable record medium for storing a program, the record medium having the program of realizing:
a first function for receiving item orders from a user at an electronic commerce business shopping mall;
a second function for notifying the user that an amount of the ordered items may be paid in a combination of various payment methods and plural delivery destinations may be processed as to one order;
a third function for storing diverse payment information in association with the user's item order according to user's selections as to the payment methods and confirming payments according to payment methods; and
a fourth function for storing diverse delivery information in association with an order according to the user's selections as to delivery methods and processing deliveries according to the delivery methods.

19. A method for processing payments and deliveries in the electronic commerce business, which is applied to a communication system, comprising steps of:
(S1) receiving item orders from a user at an electronic commerce business shopping mall;
(S2) notifying the user of the possibility of installments, and that the an amount of the ordered items may be paid in a combination of various payment methods and plural delivery destinations may be processed as to one order if the user selects the installments;
(S3) storing diverse payment information in association with the user's item order according to user's selections as to the payment methods and confirming payments according to payment methods;
(S4) storing diverse delivery information in association with an order according to the user's selections as to delivery methods and processing deliveries according to the delivery methods;
(S5) notifying the user that the amount of the ordered items may be paid in a combination of the various payment methods if the user wants to pay the remaining amount after the completion of the delivery; and
(S6) storing the diverse payment methods according to the user's selections as to the payment method and confirming the payment according to the payment method.

20. A computer-readable record medium, realizing:
a first function for receiving item orders from a user at an electronic commerce business shopping mall;
a second function for notifying the user of the possibility of installments, and that the an amount of the ordered items may be paid in a combination of various payment methods and plural delivery destinations may be processed as to one order if the user selects the installments;
a third function for storing diverse payment information in association with the user's item order according to user's selections as to the payment methods and confirming payments according to payment methods;
a fourth function for storing diverse delivery information in association with an order according to the user's selections as to delivery methods and processing deliveries according to the delivery methods;
a fifth function for notifying the user that the amount of the ordered items may be paid in a combination of the various payment methods if the user wants to pay the remaining amount after the completion of the delivery; and
a sixth function for storing the diverse payment methods according to the user's selections as to the payment method and confirming the payment according to the payment method.
